(19) United States
(12) Patent Application Publication
(10) Pub. No.: US 2008/0246238 A1
(43) Pub. Date: Oct. 9, 2008

(54) Folding structure of a golf cart

(76) Inventor: Fang-Li Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,759

(22) Filed: Apr. 4, 2007

(51) Int. Cl. B62B 1/04

(52) U.S. Cl. 280/47.18

(57) ABSTRACT

A foldable golf cart has a folding mechanism interposed between a handle part and a frame; the frame has first and second rod parts; the folding mechanism includes a fixed piece secured to the first rod part, an acting piece positioned around the second rod part in a movable manner, a cylinder interposed between the fixed piece and the acting piece, a connecting rod, and a cam-headed pressing bar, which is pivoted to one end of the connecting rod at its cam-shaped head for moving the folding mechanism between a loosening configuration and a fixing one; the fixed piece, the acting piece and the cylinder have opposing toothed sides; the connecting rod is passed through the fixed piece, the acting piece, and the cylinder, and securely joined at other end to a threaded element positioned on an outer side of the fixed piece.

### BACKGROUND OF THE INVENTION

1. Field of the Invention

The present invention relates to a folding structure of a golf cart, more particularly one, which can fix a handle part of a golf cart firmly in position, and allows position adjustment of the handle part.

2. Brief Description of the Prior Art

Ordinary golf carts comprise a push/pull handle part, a frame, and a chassis equipped with wheels. And, folding golf carts are very common, wherein a push/pull handle part and a chassis can be angularly displaced relative to a frame.

Referring to FIG. 5, a currently existing foldable golf cart comprises a handle part 50, a frame with a pair of support rod parts 51, a middle holding member 54 securely joined to the handle part 50, a right holding member 52 joined to one said support rod part 51, a left holding member 53 joined to the other support rod part 51, a bolt 55, and a knob 56 positioned next to the left holding member 53. The middle holding member 54 is positioned between the right and the left holding members 52 and 53. The middle, the right and the left holding members 54, 52 and 53 have through holes 541, 521, and 531 respectively. The middle, the right and the left holding members 54, 52 and 53 further have toothed portions 542, 522, and 532 respectively. The bolt 55 is passed through the through holes 521, 541, and 531, and passed into and threadedly engaged with the knob 56. Therefore, the knob 56 can be turned tight so as to make the middle holding member 54 engage the right and the left holding members 52 and 53, and it can be turned loose so as to allow folding of the golf cart. Owing to existence of the toothed portions 522, 532, and 542 of the holding members 52, 53 and 54, the handle part 50 can be adjusted to a suitable position according to the user's need. However, the above folding structure has the following disadvantages:

1. It takes relatively much time to turn the knob between the fixing position and the loosening one. The handle part will move relative to the support rod parts of the frame undesirably if the knob isn't turned tight enough. And, the holding members are prone to break if the knob is turned too tight.

2. Because the support rod parts of the frame aren't flexible, it is relatively difficult for the user to make the support rod parts closer to each other to fix the handle part to the frame merely by means of turning the knob. In other words, the folding structure isn't convenient to use.

Referring to FIG. 6, another currently existing golf cart folding structure comprises a handle with a rod part 60, a frame with a support rod part 61, a bolt 64, and a knob 65. The rod part 60 of the handle is inserted in the support rod part 61 of the frame, and has opposing through holes 601, and an elastic mechanism 602 projecting to outside. The support rod part 61 has a detainment hole 62 for receiving the elastic mechanism 602, and opposing through holes 63. The bolt 64 is passed through the through holes 601 and 63, and passed into and threadedly engaged with the knob 65. After the handle is pivoted to the in-use position with the elastic mechanism 602 on the rod part 60 being received in the detainment hole 62, it can be fixed to the frame by means of turning the knob 65 tight. And, the handle can be angularly displaced relative to the frame so as to fold the golf cart after the knob 65 is loosened and the elastic mechanism is pressed and separated from the detainment hole 62. Such a folding structure has the following disadvantages:

1. It isn't convenient to use because it takes relatively much to turn the knob between the tight position and the loose one.

2. The handle can only be pivoted to either an in-use (open) position or a not-in-use (folded) one, incapable of being adjusted in position according to the user's need when the golf cart is in an unfolded in-use position.

Therefore, it is a main object of the invention to provide an improvement on a golf cart folding structure to overcome the problems.

### SUMMARY OF THE INVENTION

A folding structure according to an embodiment of the present invention includes a folding mechanism interposed between a handle part and a frame. The frame has first and second rod parts The folding mechanism includes a fixed piece secured to the first rod part, an acting piece positioned around the second rod part in a movable manner, a cylinder interposed between the fixed piece and the acting piece, a connecting rod; the fixed piece, the acting piece and the cylinder have opposing toothed sides. The connecting rod is passed through the fixed piece, the acting piece, and the cylinder, and securely joined at one end thereof to a threaded element positioned on an outer side of the fixed piece. The folding mechanism further has a cam-headed pressing bar, which is pivoted at its cam-shaped head to the other end of the connecting rod for moving the folding mechanism between a loosening configuration and a fixing one.

### BRIEF DESCRIPTION OF THE DRAWINGS

The present invention will be better understood by referring to the accompanying drawings, wherein:

FIG. 1 is a perspective view of the present invention,

FIG. 2 is a fragmentary exploded perspective view of the present invention,

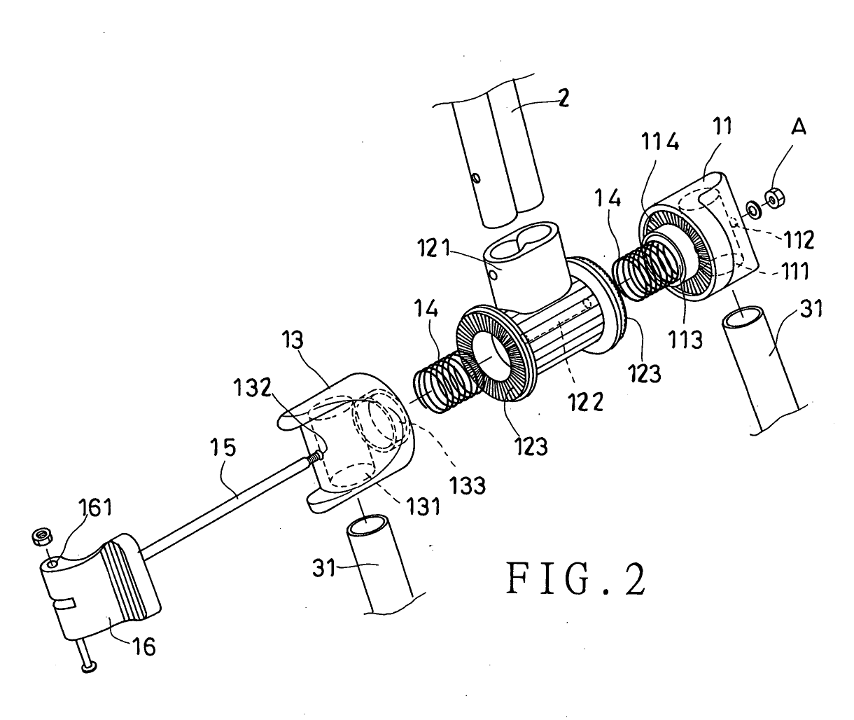

FIG. 3 is a partial sectional view of the present invention,

FIG. 4 is a partial section of the present invention in operation,

FIG. 5 is a sectional view of the first prior art, and

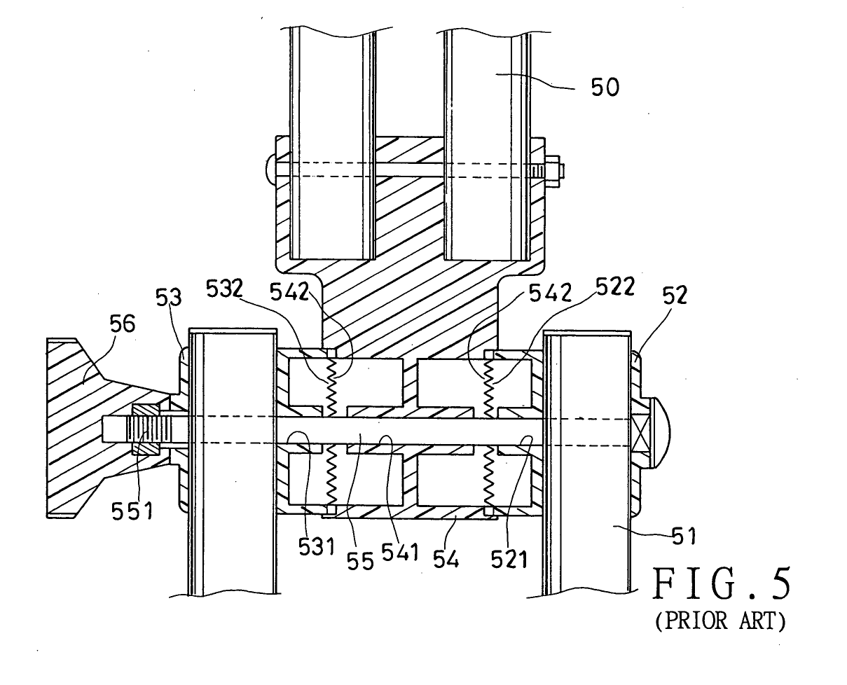

FIG. 6 is a sectional view of the second prior art.

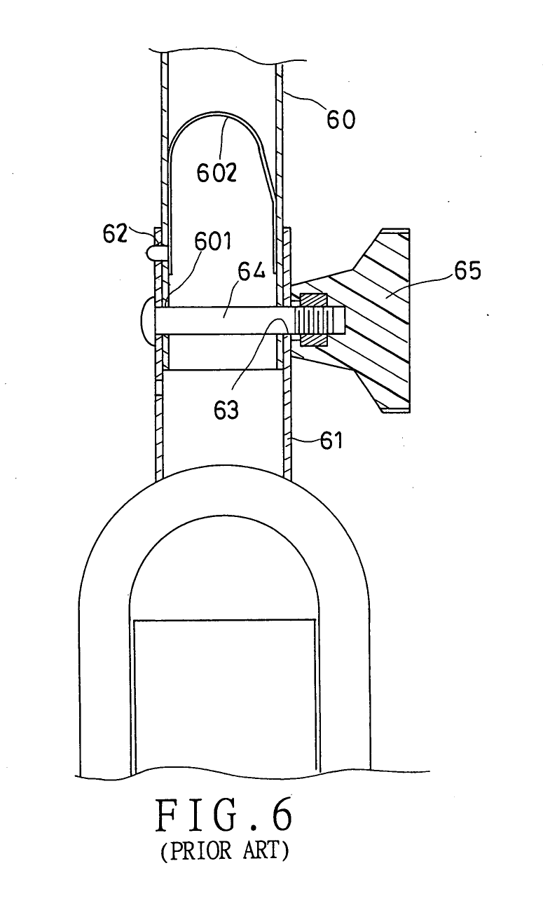

### DETAILED DESCRIPTION OF THE PREFERRED EMBODIMENTS

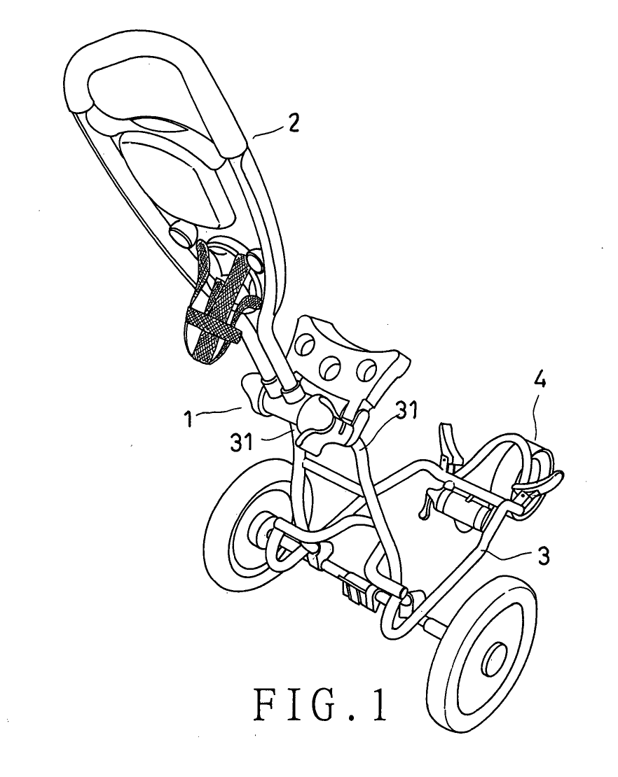

Referring to FIG. 1, a preferred embodiment of a foldable golf cart of the present invention includes:

a handle part 2;

a frame 3 having two support rod parts 31;

a folding mechanism 1 interposed between the handle part and the support rod parts 31 of the frame 3 for allowing the handle part 2 to pivot relative to the support rod parts 31; the folding mechanism 1 comprises:

(a) a fixed piece 11 securely joined to a first one of the support rod parts 31 of the frame 3; the fixed piece 11 has a connecting hole 111, in which the first support rod part 31 is inserted; the fixed piece 11 has a through hole 112 extending in a direction perpendicular to that of the connecting hole 111; the fixed piece 11 has a hollow holding portion 113 and an annular toothed portion 114 around one end of the through hole 112;

(b) an acting piece 13 positioned around a second one of the support rod parts 31 of the frame 3 in a movable manner, the acting piece 13 has a slot-shaped receiving hole 131, in which the second support rod part 31 is received; the acting piece 13 has a through hole 132 extending in a direction perpendicular to that of the slot-shaped receiving hole 131; the acting piece 13 has a hollow holding portion 133 and an annular toothed portion 134 around one end of the through hole 132, facing in an opposite direction of the hollow holding portion 113 and the annular toothed portion 114 of the fixed piece 11;

(c) a holding cylinder 12 interposed between the fixed piece 11 and the acting piece 13, the holding cylinder 12 has a fixing portion 121, and the handle part 2 is inserted in and secured to the fixing portion 121 at one end thereof; the holding cylinder 12 has an axial through hole 122, and annular toothed portions 123 on first and second ends thereof for engaging the annular toothed portions 114 and 134 of the fixed piece 11 and the acting piece 14 respectively;

(d) first and second elastic elements 14, the elastic elements 14 are received in the hollow holding portions 113 and 133 of the fixed piece 11 and the acting piece 13 respectively, and pressed against the first and the second ends of the holding cylinder 12;

(e) a connecting rod 15 passed through the through hole 132 of the acting piece 13, the axial through hole 122 of the holding cylinder 12, the through hole 112 of the fixed piece 11, and the support rod parts 31 of the frame 3 as well; the connecting rod 15 is at one end firmly joined to a threaded assembling element (A) positioned on an outer side of the fixed piece 11; and

(f) a pressing bar 16 with a cam-shaped head portion 161; the pressing bar is pivoted to the other end of the connecting rod 15 at the cam-shaped head portion 161 thereof.

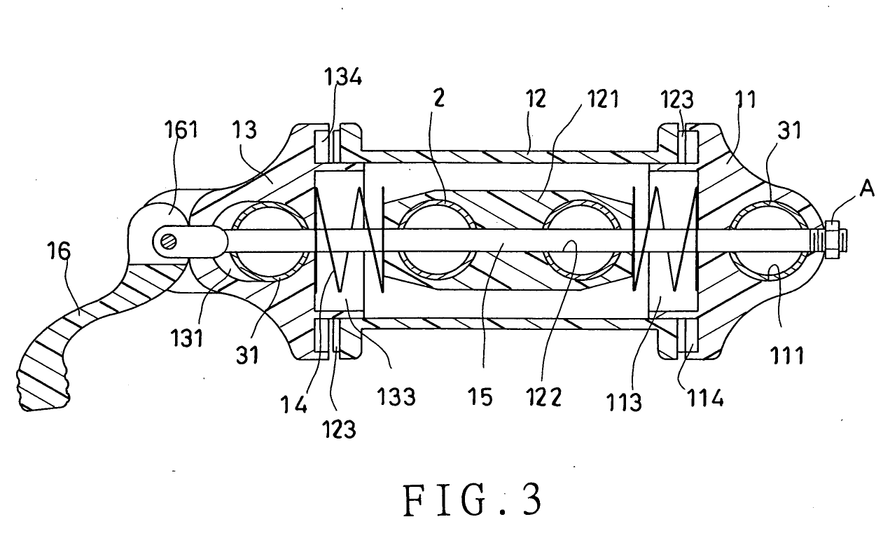

FIG. 3 is a sectional view of the folding mechanism 1 in a loosening configuration, wherein the pressing bar 16 is pivoted to a first non-acting position, and in turn the first elastic element 14 biases the holding cylinder 12 away from the fixed piece 11 in order for the first annular toothed portion 123 of the holding cylinder 12 to disengage the annular toothed portion 114 of the fixed piece 114, and the second elastic element 14 biases the acting piece 13 away from the holding cylinder 12 in order for the annular toothed portion 134 of the fixed piece 13 to disengage the second annular toothed portion 123 of the holding cylinder 12; when the folding mechanism is in the loosening configuration, the second rod part 31 of the frame 3 will be received in a right section of the slot-shaped receiving hole 131 of the acting piece 13; thus, the handle part 2 can be pivoted relative to the frame 3 so as to be close to the frame 3 and reduce dimensions of the golf cart, and it can be pivoted so as to stretch the golf cart for allowing the golf cart to be used, as shown in FIG. 1. And, the handle part 2 can be adjusted to a suitable position according to the user's need.

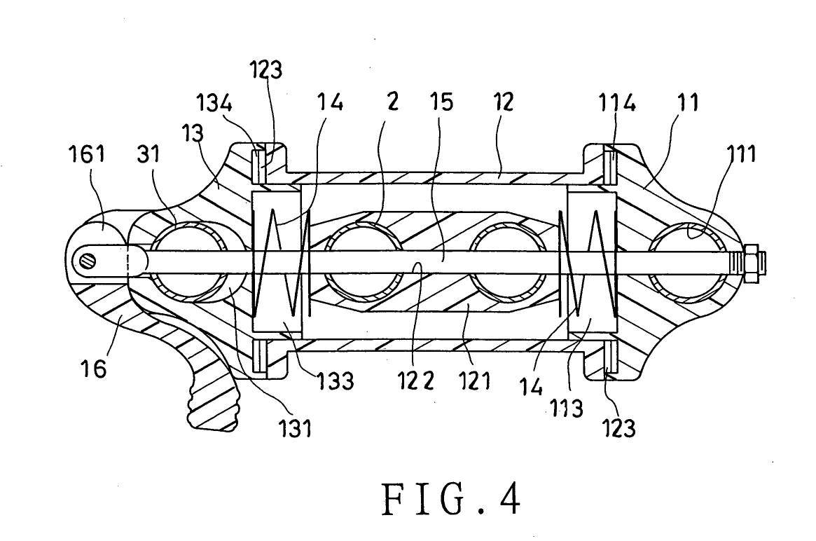

FIG. 4 is a sectional view of the folding mechanism 1 in a fixing configuration, wherein the pressing bar 16 is pivoted to a second acting position so as to push the acting piece 13 towards the holding cylinder 12 and the holding cylinder 12 towards the fixed piece 11, and in turn the annular toothed portion 134 of the acting piece 13 engage the second annular toothed portion 123 of the holding cylinder 12, and the first annular toothed portion 123 engage the annular toothed portion 114 of the fixed piece 11; when the folding mechanism is in the fixing configuration, the second rod part 31 of the frame 3 will be received in a left section of the slot-shaped receiving hole 131 of the acting piece 13; thus, the handle part 2 is fixed in position, incapable of being moved relative to the support rod parts 31 of the frame 3.

Furthermore, such a folding mechanism can be interposed between the other end of the frame 3 and a front wheel mechanism 4 of the golf cart in order for allowing the front wheel mechanism 4 to be adjusted in position and pivoted relative to the frame 3 between an in-use position and a not-in-use one.

From the above description, it can be seen that the present invention has the following advantages over the prior arts:

1. The folding mechanism can be easily operated between a loosening configuration and a fixing one by means of pivoting the pressing bar on the connecting rod. Therefore, it is relatively convenient to use.

2. The pressing bar doesn't have to cause the support rod parts of the frame to bend or change shape when it is operated for moving the folding mechanism between the loosening configuration and the fixing one. Therefore, the handle part will be much firmer in its in-use position.

3. The folding mechanism also can be interposed between the frame and the front wheel mechanism besides being interposed between the frame and the handle part.

What is claimed is:

1. A folding structure of a golf cart,
said golf cart comprising
a handle part;
a frame having first and second support rod parts;
a front wheel mechanism;
a folding mechanism interposed between said handle part and said support rod parts of said frame for allowing said handle part to pivot relative to said frame; said folding mechanism comprising:
(a) a fixed piece securely joined to said first support rod part; said fixed piece having a connecting hole receiving said first support rod part; said fixed piece having a through hole perpendicular to said connecting hole; said fixed piece having a hollow holding portion and an annular toothed portion around one end of said through hole;
(b) an acting piece positioned around said second support rod part of said frame in a movable manner, said acting piece having a slot-shaped receiving hole receiving said second support rod part; said acting piece having a through hole perpendicular to said slot-shaped receiving hole; said acting piece having a hollow holding portion and an annular toothed portion around one end of said through hole thereof;
(c) a holding cylinder interposed between said fixed piece and said acting piece, said holding cylinder having a fixing portion securely joined to said handle part; said holding cylinder having an axial through hole; said holding cylinder having annular toothed portions on first and second ends thereof for engaging said annular toothed portions of said fixed piece and said acting piece respectively;
(d) first and second elastic elements respectively received in said hollow holding portions of said fixed piece and said acting piece and pressed against said first and said second ends of said holding cylinder;
(e) a connecting rod passed through said through holes of said acting piece, said fixed piece, and said axial through hole of said holding cylinder as well as said support rod parts of said frame; said connecting rod being at one end firmly joined to a threaded assembling element positioned on an outer side of said fixed piece; and
(f) a pressing bar having a cam-shaped head portion; said pressing bar being pivoted to other end of said connecting rod at said cam-shaped head portion thereof.

2. The folding structure of a golf cart as recited in claim 1, wherein said fixing portion of said holding cylinder is formed in such a position as to face said handle part.

3. The folding structure of a golf cart as recited in claim 1, wherein said folding mechanism is interposed between said frame and said front wheel mechanism.
